(19) United States
(12) Patent Application Publication
(10) Pub. No.: US 2011/0226813 A1
(43) Pub. Date: Sep. 22, 2011

(54) OVOID CONTAINER

(76) Inventor: Frank E. Semersky, Holland, OH (US)

(21) Appl. No.: 13/050,303

(22) Filed: Mar. 17, 2011

Related U.S. Application Data
(60) Provisional application No. 61/314,748, filed on Mar. 17, 2010.

(51) Int. Cl. B67D 7/84; B65D 37/00

(52) U.S. Cl. 222/186; 222/206; 222/215; 222/212

(57) ABSTRACT

A blow molded container for dispensing a fluid material is disclosed, the container including an ovoid hollow body formed from a flexible material, a means for handling formed on the hollow body, and an opening formed in the hollow body providing fluid communication with an interior thereof. The container is adapted to hold an egg substitute product and to minimize a complexity of use of the egg substitute product for cooking purposes by minimizing the measurements and/or measurement conversion required by consumers.

### CROSS-REFERENCE TO RELATED APPLICATION

This application claims the benefit of priority of U.S. Provisional Patent Application Ser. No. 61/314,748 filed on Mar. 17, 2010 hereby incorporated herein by reference in its entirety.

### FIELD OF THE INVENTION

The present invention is generally directed to a squeezable fluid container, and more particularly to a squeezable fluid container having an ovoid shape.

### BACKGROUND OF THE INVENTION

Many modern consumers prefer flexible plastic containers over traditional inflexible containers such as glass bottles or metal containers for a variety of reasons. Glass bottles may crack, chip, or break. Metal containers can, at times, be difficult to open. Many metal containers, once open, can have sharp edges or burrs. Furthermore, the cost to manufacture glass and metal containers is often greater than the cost to manufacture blow molded plastic containers.

Certain viscous fluids, such as ketchup and certain salad dressings, may be more readily poured from flexible or plastic containers than from glass bottles or metal containers of comparable shape. Also, many consumers are generally able to extract more fluid contents from a flexible or squeezable plastic container than from inflexible containers of comparable shape and volume. Finally, flexible plastic containers, when empty, are generally more readily compactable than certain metal and most glass containers. Such relative ease of disposal of plastic containers can be an important consumer consideration in deciding which brand of a particular fluid product to purchase.

Thus, in light of a general preference by consumers for flexible plastic fluid containers, a variety of flexible plastic containers, designed to meet a number of specific consumer demands and to provide certain desirable features, is known in the art.

U.S. Pat. No. Re. 24,251 to Kaplan et al., for example, discloses a fluid-dispensing container formed from two sheets of flexible plastic material for containing desired amounts of liquid. Such a container is said to be particularly adapted for shipment in sealed condition, and is further said to be provided with a tearable strip along one end thereof to facilitate opening of the container. Such a strip, when torn, can thus be utilized for purposes of dispensing the contained liquid from the container, as desired, upon application of a pressure to the sidewalls of the container. See also U.S. Pat. No. 4,717,046 to Brogli. However, not all flexible plastic fluid containers need to be made from two sheets of plastic sealed together along edge margins thereof, as disclosed in Kaplan et al. In U.S. Pat. No. 2,517,027 to Rado, for example, there is disclosed a collapsible tube-like container adapted to house viscous fluids such as pastes.

Simplicity of overall design can also be an important consideration, particularly when it is desirable to reduce manufacturing cost of each flexible plastic fluid container unit. Thus, while it is possible to manufacture fluid containers having necked-down fluid-discharge portions, as is disclosed in U.S. Pat. Nos. 3,815,794 and 3,878,977, both to Carlisle, and U.S. Pat. No. 4,163,509 to Amneus, it is desirable to produce flexible-plastic fluid containers that are generally rectangular in shape. Indeed, such a shape tends to reduce material waste and production cost per flexible-plastic fluid container unit. The flexible-plastic fluid containers disclosed in U.S. Pat. No. Re. 24,251 to Kaplan et al. and U.S. Pat. No. 4,491,245 to Jamison disclose flexible-plastic fluid containers that are generally rectangular in shape. Unfortunately, in flexible-plastic fluid containers of this type, undesired container deformation tends to interfere with desired fluid-discharge.

One ingredient frequently used in food preparation and cooking is eggs. Whole eggs, including an egg white and yolk, contain undesirable constituents such as fat, cholesterol, and calories. Egg substitutes may be eaten or used for cooking in lieu of eggs to provide flavor or for use as a rising or binding agent without the undesirable constituents. One popular egg substitute is sold under the trademark EGG BEATERS® by CONAGRA Foods RDM, Inc. However, the popularity of egg substitutes has largely been for consumption of the egg substitutes, and not for the use of egg substitutes in cooking. It is believed that consumers have found cooking with egg substitutes is difficult due to typical egg substitutes being sold in pint sized or larger containers. Thus, determining an amount of egg substitute equivalent to a whole egg requires a conversion chart and separate liquid measuring cups. Furthermore, once the egg substitute container is opened, the contents thereof must be used within a few days to avoid spoiling. Accordingly, it would be desirable to develop a container that is adapted to hold an egg substitute product and to minimize a complexity of use of the egg substitute product for cooking purposes by minimizing the measurements and/or measurement conversion required by consumers.

### SUMMARY OF THE INVENTION

Concordant and congruous with the present invention, a container adapted to hold an egg substitute product and to minimize a complexity of use of the egg substitute product for cooking purposes by minimizing the measurements and/or measurement conversion required by consumers has surprisingly been discovered.

In one embodiment of the invention, a blow molded container for dispensing a fluid material comprises an ovoid hollow body formed from a flexible material; a means for handling formed on the hollow body; and an opening formed in the hollow body providing fluid communication with an interior thereof,

### BRIEF DESCRIPTION OF THE DRAWINGS

The above, as well as other advantages of the present invention, will become readily apparent to those skilled in the art from the following detailed description of a preferred embodiment when considered in light of the accompanying drawings in which:

FIG. 1 is a side elevational view of an ovoid container according to an embodiment of the invention;

FIG. 2 is a top view of the ovoid container of FIG. 1;

FIG. 3 is a cross-sectional view of a blow mold used to form the container of FIGS. 1 and 2;

FIG. 4 is a perspective view of an ovoid container according to another embodiment of the invention;

FIG. 5 is a side elevational view of an ovoid container according to another embodiment of the invention;

FIG. 6 is a side elevational view of an ovoid container according to another embodiment of the invention;

FIG. 7 is a side elevational view of an ovoid container according to another embodiment of the invention; and

FIG. 8 is a perspective view of a plurality of the containers of FIG. 1 disposed in an egg carton.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

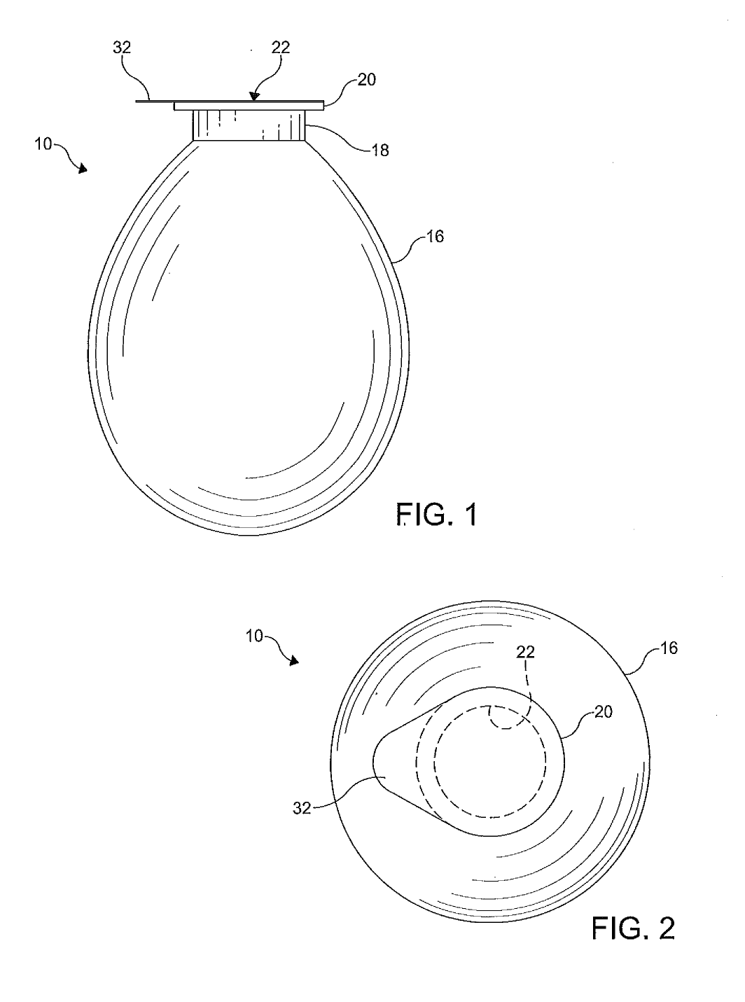

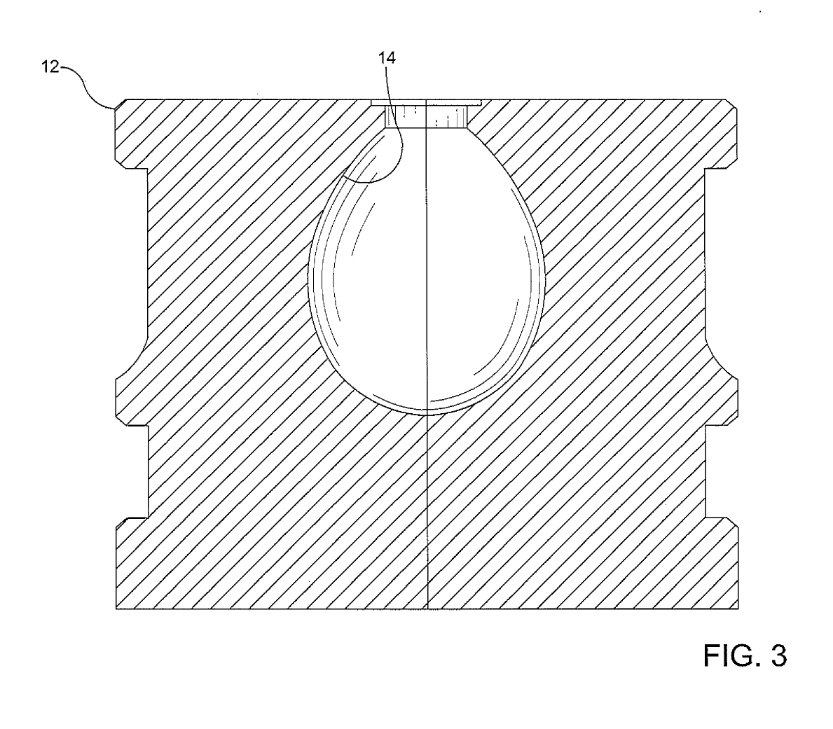

FIGS. 1 and 2 show a container 10 having an ovoid shape, also known as an egg shape. The container 10 is formed by a blow molding process as known in art in a mold 12 shown in FIG. 3. The mold 12 forms an ovoid-shaped cavity 14. The container 10 may be formed from any blow moldable material but is preferably formed from a polymeric material, such as PET, PE, HDPE, PLA, and the like. The container 10 includes a hollow body 16, a neck 18, a means for handling the container 20, and an opening 22 providing communication with an interior of the container 10.

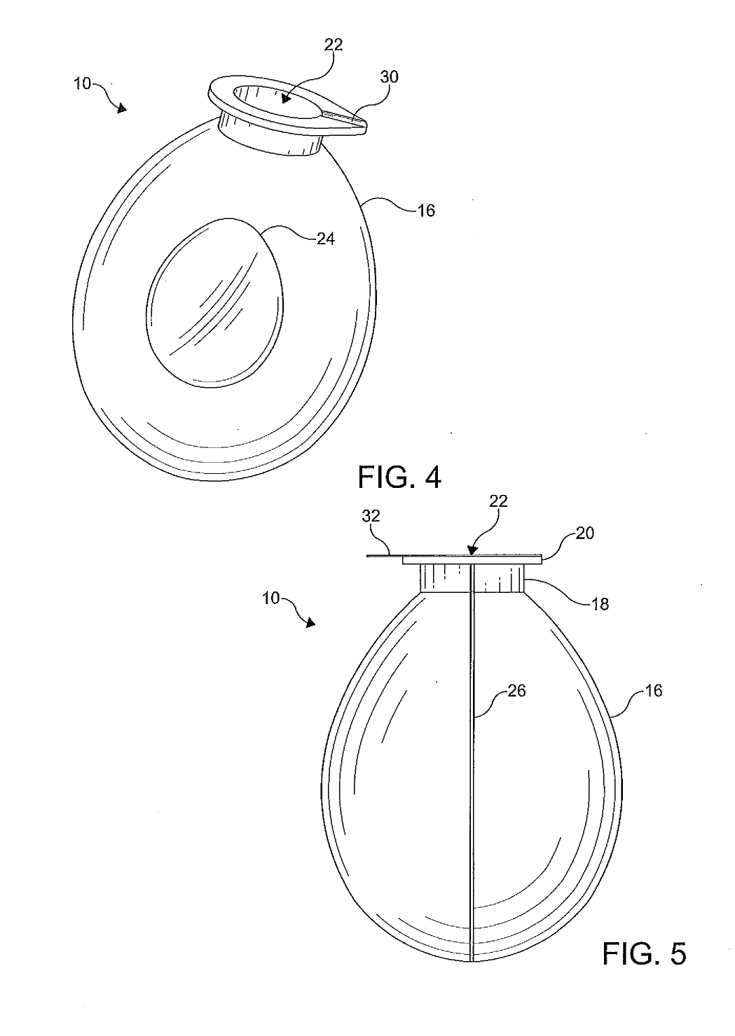

A sidewall of the hollow body 16 of the container 10 has a thickness sufficient to facilitate the squeezing of the container 10 for dispensing the contents thereof without puncturing the container 10. As shown in FIG. 4, the hollow body 16 of the container 10 includes an indentation 24 adapted to receive the finger or fingers of a user when being squeezed. Any number of indentations 24 may be formed in the container 10. As shown in FIG. 5, the sidewall of the hollow body 16 includes a seam 26 or a crease formed along a longitudinal axis of the container 10. The seam 26 may have a thickness less than the thickness of the remainder of the hollow body 16 to facilitate the collapse of the container 10 when the container 10 is squeezed. The seam 26 may be formed on only a portion of the container 10 or the seam 26 may be formed on opposing sides of the container 10, as desired.

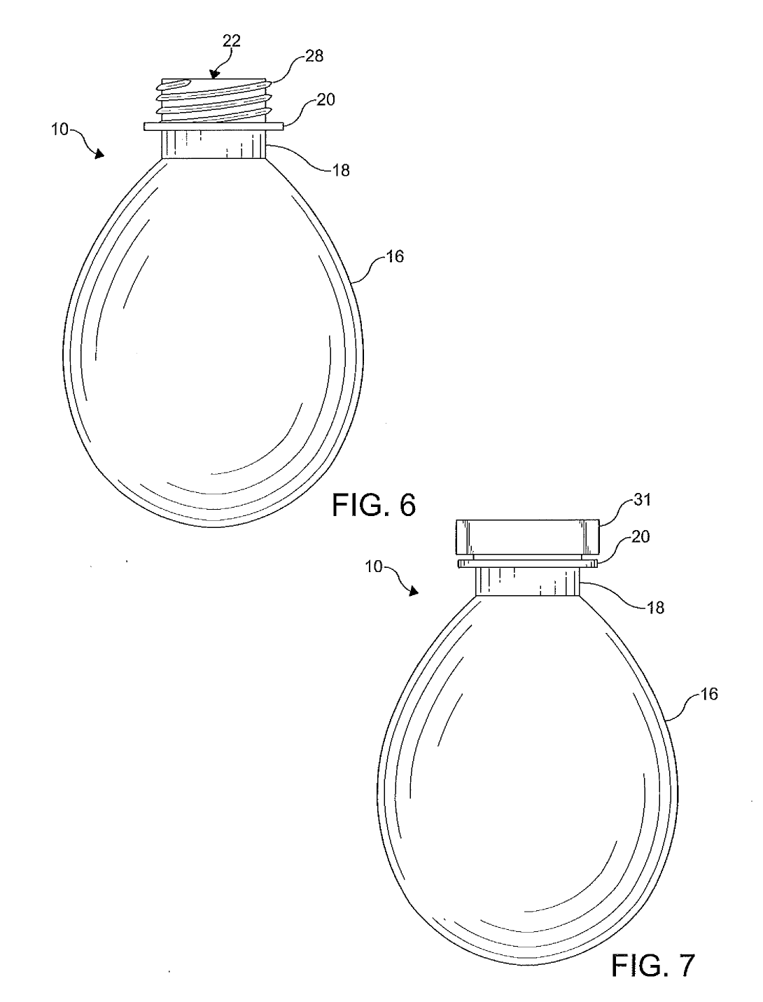

The upstanding neck 18 is formed between the hollow body 16 and the means for handling 20. In the embodiment shown in FIGS. 1 and 2, the means for handling 20 is an annular shoulder. The neck 18 and the means for handling 20 cooperate to form the opening 22. It is understood that the neck 18 may have the same thickness as the hollow body 16 or the neck 18 may have a different thickness. In the embodiment shown in FIG. 6, the opening 22 of the container 10 is formed in a threaded finish 28 adapted to receive a cooperating threaded closure (not shown). It is also understood that the means for handling 20 may be any protuberance or indentation adapted to cooperate with blow molding machinery known in the art to transport a preform (not shown) used to form the container 10 and the container 10 therefrom. As shown in FIG. 4, a spout 30 may be formed in the container 10 adjacent the opening 22 to facilitate a pouring of the contents therefrom.

As best shown in FIG. 2, the opening 22 is an aperture providing communication with a hollow interior of the container 10. The opening 22 is sealed with a fluid-impermeable membrane 32 such as a foil tab or a plastic tab adhered to the neck 18. The impermeable membrane 32 may be formed in the shape of a feather(s) or the impermeable membrane 32 may have another design or shape as desired.

In the embodiment of the invention shown in FIG. 7, the opening 22 may be sealed by a selectively removable peelable or frangible plastic tab 31 formed at or about the same time the container 10 is filled. The tab 31 may be formed from the same material as the hollow body 16 of the container 10. The plastic tab 31 may be infrangible, requiring scissors or another object for removal. In yet another embodiment of the invention, the container 10 includes a frangible seam or fault similar to the seam 26 of FIG. 5. When the container 10 is squeezed with a sufficient force, the frangible seam 26 opens to create an opening (not shown). Alternatively, the frangible seam 26 may be formed in or around a neck 18 of the container 10. By forming the frangible seam 26 in the container 10, the cracking and opening of an egg is simulated. In each of the foregoing embodiments, the container 10 would be sealed upon filling with a liquid egg substitute, powdered eggs, or other liquids or powders, such as protein and vitamin supplements.

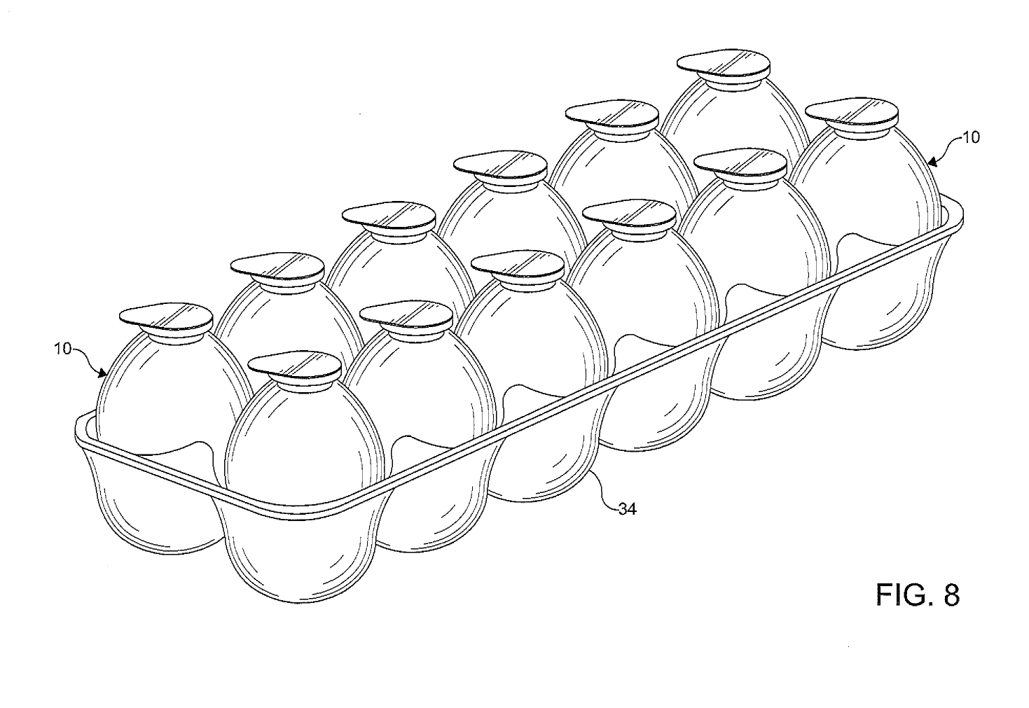

To form the container 10, extrusion blow molding techniques and processes well known in the art may be utilized. Alternatively, injection blow molding techniques and processes well known in the art may be utilized. Once a plurality of containers 10 is formed, the plurality of containers 10 may be packaged in an egg carton 34, as shown in FIG. 8. The egg carton 34 includes a plurality of indentations, each indentation adapted to receive one of the ovoid containers 10. The indentations maintain the containers 10 in an upright position. Use of the containers 10 with egg cartons 34 facilitates stacking and placement of egg substitute products side-by-side with real eggs in grocery stores.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A blow molded container for dispensing a fluid material comprising:
an ovoid hollow body formed from a flexible material;
a means for handling formed on the hollow body; and
an opening formed in the hollow body providing fluid communication with an interior thereof.

2. The blow molded container of claim 1, wherein the means for handling is an annular shoulder.

3. The blow molded container of claim 1, further comprising a fluid-impermeable membrane adhered to the container over the opening.

4. The blow molded container of claim 1, further comprising a neck formed between the hollow body and the means for handling.

5. The blow molded container of claim 4, further comprising a threaded finish formed adjacent the means for handling and having the opening formed therein.

6. blow molded container of claim 1, further comprising at least one indentation formed in the hollow body.

7. The blow molded container of claim 1, further comprising a seam formed in the hollow body of the container.

8. The blow molded container of claim 7, wherein the seam has a thickness less than a thickness of the hollow body.

9. The blow molded container of claim 7, wherein the seam is frangible.

10. The blow molded container of claim 7, wherein the seam is formed along a longitudinal axis of the container.

11. The blow molded container of claim 1, further comprising a spout formed adjacent the opening.

12. The blow molded container of claim 1, further comprising a selectively removable tab formed over the opening to seal contents within the container.

13. The blow molded container of claim 12, wherein the tab is formed from the same material forming the hollow body.

14. The blow molded container of claim 13, wherein the tab is frangible.

15. The blow molded container of claim 1, further comprising an egg carton having a plurality of indentations therein, each indentation adapted to receive an ovoid container, wherein an ovoid container is disposed in each indentation of the egg carton.
